(19) United States
(12) Patent Application Publication
(10) Pub. No.: US 2026/0004982 A1
(43) Pub. Date: Jan. 1, 2026

(54) SWITCH ASSEMBLY WITH CANTILEVER

(71) Applicant: Joyson Safety Systems Acquisition LLC, Auburn Hills, MI (US)

(72) Inventors: Filippo Leone, Holly, MI (US); Erick Staszak, Oxford, MI (US)

(21) Appl. No.: 19/251,284

(22) Filed: Jun. 26, 2025

Related U.S. Application Data
(60) Provisional application No. 63/664,921, filed on Jun. 27, 2024.

(51) Int. Cl. H01H 15/10; B60N 2/02; G01L 5/22

(52) U.S. Cl. CPC H01H 15/102; B60N 2/0228; G01L 5/22; H01H 2300/008

(57) ABSTRACT

A switch assembly includes an actuator having an axis of rotation and defining a groove. An interface plate defines a cantilever having a fixed end and a free end, wherein the free end is disposed within the groove of the actuator. The switch assembly further includes a force sensor coupled to the interface plate adjacent the fixed end of the actuator. When a first force causes the actuator to rotate about the axis of rotation, the actuator exerts a second force on the cantilever causing the cantilever to bend about the fixed end. The bending of the cantilever about the fixed end induces a third force exerted on the fixed end which is measured by the force sensor to determine whether the switch has been intentionally actuated by an operator.

### TECHNICAL FIELD

The present disclosure relates to human machine interface devices. In one example, the disclosure relates to a switch assembly for controlling a vehicle function. Vehicles may include, for example, automobiles, boats, trains, aircrafts, and spacecrafts.

### BACKGROUND

Switches (e.g., buttons) are installed throughout modern vehicles, such as automobiles, to allow passengers to interact with various vehicle systems. Mechanical switches that require a relatively large degree of motion to operate, such as those that move a conductive element into contact with another conductive element, can be quite large and require design tradeoffs. By minimizing the size of switches, space can be saved within the passenger cabin of the vehicle which can enable new design considerations for other components of the vehicle.

For example, the push to use electric propulsion systems in automobiles necessitates large battery packs and other electronics which are not present in automobiles with internal combustion engines. These additional components can take up valuable space within the vehicle cabin, however passengers expect to be able to interact with the vehicle using switches as they always have in the past. Using switches with smaller profiles (e.g., physical dimensions) is one example of a space-saving technique that can counteract the effects of shifting to electric vehicles. Therefore, there is a need to produce a switch assembly that is smaller in size but still fully functional and intuitive to use. Such a switch assembly can be used in vehicles or in any other human machine interface where a smaller switch can be advantageous.

### SUMMARY

In various implementations, a switch assembly comprises an actuator comprising an axis of rotation and defining a groove, an interface plate defining a cantilever having a fixed end and a free end, the free end being disposed within the groove, and a force sensor coupled to the interface plate adjacent the fixed end. When a first force causes the actuator to rotate about the axis of rotation, the actuator exerts a second force on the cantilever causing the cantilever to bend about the fixed end.

In some implementations, the bending of the cantilever about the fixed end induces a third force exerted on the fixed end and measured by the force sensor. In some implementations, the third force comprises a bending moment.

In some implementations, the switch assembly further comprises a housing, wherein the actuator is coupled to the housing. In some implementations, the housing is coupled to the interface plate. In some implementations, the housing defines a support and the interface plate comprises a surface, wherein the support abuts the surface adjacent the fixed end. In some implementations, the switch assembly further comprises a touch overlay coupled to the housing. In some implementations, the touch overlay is coupled to the actuator using an interference fit. In other implementations, the touch overlay is coupled to the housing using an adhesive.

In some implementations, the interface plate is a printed circuit board (PCB). In some implementations, the force sensor is coupled to the PCB. In some implementations, the force sensor is directly reflowed onto the PCB.

In other implementations, the force sensor is coupled to a printed circuit board (PCB), wherein the PCB is coupled to the interface plate such that the force sensor is adjacent the fixed end. In some implementations, the PCB is coupled to the interface plate using an adhesive. In some implementations, the force sensor is directly reflowed onto the PCB.

In some implementations, the switch assembly further comprises a controller having a processor and a memory, wherein instructions stored on the memory cause the processor to receive a signal from the force sensor. In some implementations, the controller is coupled to the PCB. In some implementations, the switch assembly is installed in a vehicle and the instructions further cause the processor to control a vehicle function based on the signal received from the force sensor. In some implementations, controlling a vehicle function comprises controlling a seating position of a vehicle seat, wherein the seating position comprises a seat back recline position, a seat bottom forward/rearward position, or a seat lumbar support position.

In various implementations, a switch assembly comprises an actuator comprising a cantilever having a fixed end and a free end, a bridge, and an arm, the bridge coupled to the fixed end and the arm coupled to the free end. The switch assembly also comprises a force sensor coupled to the cantilever adjacent the fixed end. When a first force is exerted on the arm, the arm moves the free end causing the cantilever to bend about the fixed end.

In some implementations, the bending of the cantilever about the fixed end induces a second force exerted on the fixed end and measured by the force sensor. In some implementations, the second force comprises a bending moment.

In some implementations, the switch assembly further comprises an interface plate, wherein the actuator is coupled to the interface plate. In some implementations, the switch assembly further comprises a housing. In some implementations, the switch assembly further comprises a touch overlay coupled to the housing. In some implementations, the touch overlay is coupled to the housing using an adhesive. In some implementations, the touch overlay is coupled to the actuator. In some implementations, the touch overlay is coupled to the actuator using an interference fit.

In some implementations, the force sensor is directly coupled to a printed circuit board (PCB), wherein the PCB is coupled to the actuator such that the force sensor is adjacent the fixed end. In some implementations, the PCB is coupled to the actuator using an adhesive. In some implementations, the force sensor is directly reflowed onto the PCB.

In some implementations, the switch assembly further comprises a controller having a processor and a memory, wherein instructions stored on the memory cause the processor to receive a signal from the force sensor. In some implementations, the controller is coupled to the PCB. In some implementations, the switch assembly is installed in a vehicle and the instructions further cause the processor to control a vehicle function based on the signal received from the force sensor. In some implementations, controlling a vehicle function comprises controlling a seating position of a vehicle seat, wherein the seating position comprises a seat back recline position, a seat bottom forward/rearward position, or a seat lumbar support position.

### BRIEF DESCRIPTION OF THE DRAWINGS

The drawings are merely exemplary to illustrate steps, structure, and certain features that can be used singularly or in combination with other steps, structures, and features. The disclosure should not be limited to the implementations shown. Similar reference numerals (e.g., 101, 201, etc.) represent similar steps, structures, and features throughout the implementations shown.

FIG. 1 is perspective view of a first implementation of a switch assembly.

FIG. 2 is an exploded view of the switch assembly of FIG. 1.

FIGS. 3A-3C are perspective views of a first housing of the switch assembly of FIG. 1.

FIGS. 4A-4B are perspective views of a second housing of the switch assembly of FIG. 1.

FIGS. 5A-5B are perspective views of an interface plate of the switch assembly of FIG. 1.

FIGS. 6A-6D are perspective views of an actuator of the switch assembly of FIG. 1.

FIG. 7 is a perspective view of a second implementation of a switch assembly.

FIG. 8 is an exploded view of the switch assembly of FIG. 7.

FIGS. 9A-9D are perspective views of a first housing of the switch assembly of FIG. 7.

FIGS. 10A-10C are perspective views of an interface plate of the switch assembly of FIG. 7.

FIG. 11 is a perspective view of a second housing of the switch assembly of FIG. 7.

FIGS. 12A-12D are perspective views of a first actuator of the switch assembly of FIG. 7.

FIGS. 13A-13C are perspective views of a second actuator of the switch assembly of FIG. 7.

FIG. 13D is a cross-sectional view of the second actuator of FIGS. 13A-13C taken through the plane A-A in FIG. 13A.

FIG. 14 is a side perspective view of a vehicle seat controllable by a switch assembly.

### DETAILED DESCRIPTION

The devices, systems, and methods disclosed herein provide for a switch assembly having a cantilever. The switch assembly may be used to control at least one vehicle function within a vehicle, for example an automobile. The switch assembly includes an actuator that is rotatable about an axis of rotation to bend a cantilever, wherein a force sensor disposed adjacent a fixed end of the cantilever measures an induced force on the fixed end as a result of the bending. The force sensor is coupled to an interface plate which defines the cantilever, wherein the interface plate may be, in one implementation, a rigid printed circuit board (PCB). In one representative example, as shown in the FIGURES, the switch assembly may be a seat adjustment switch for a passenger vehicle and may be used for adjustment of at least one seating position of a seat (e.g., a seat back recline position, a seat bottom forward/rearward position, or a seat lumbar support position). Other switches and uses are possible using the disclosed switch assembly.

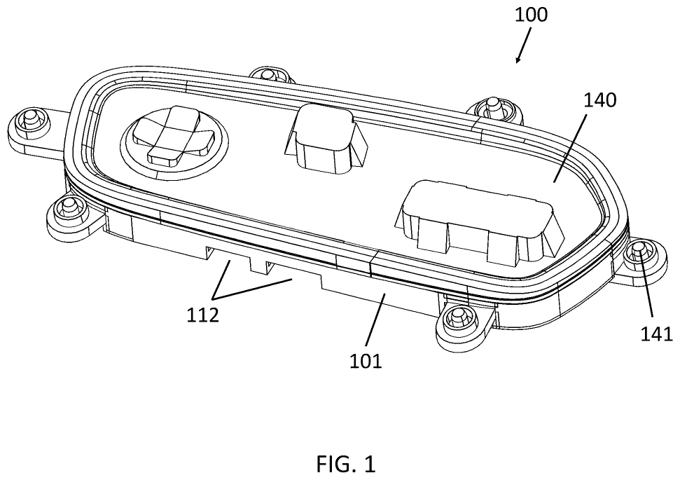

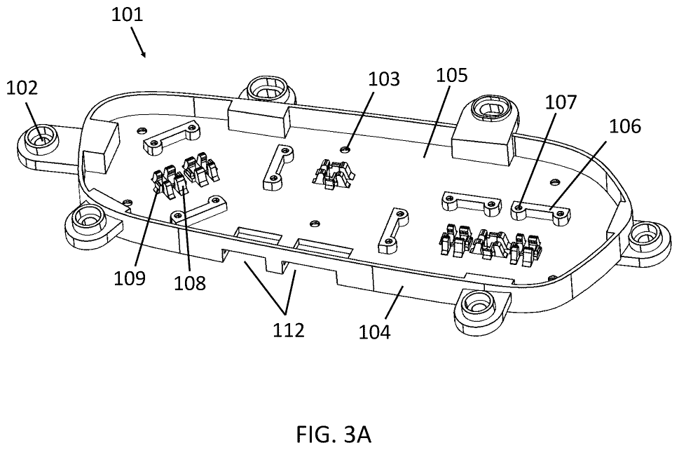

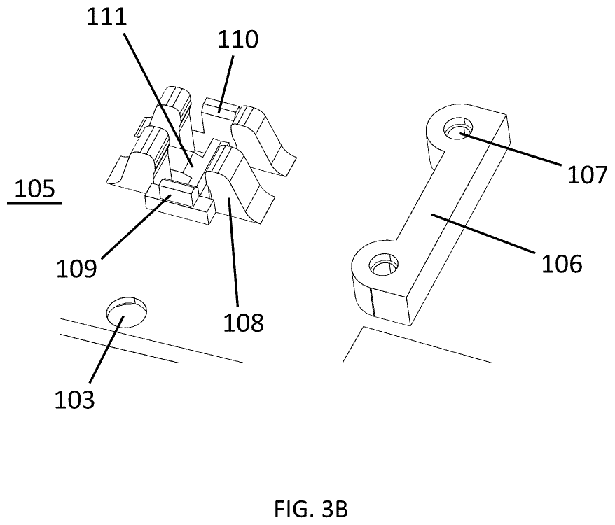

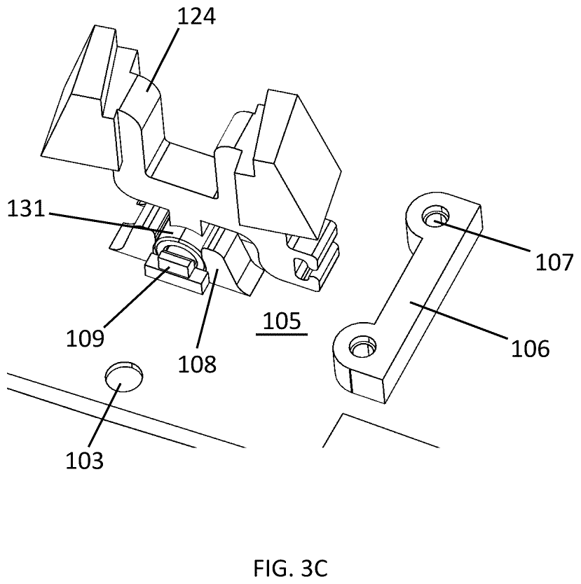

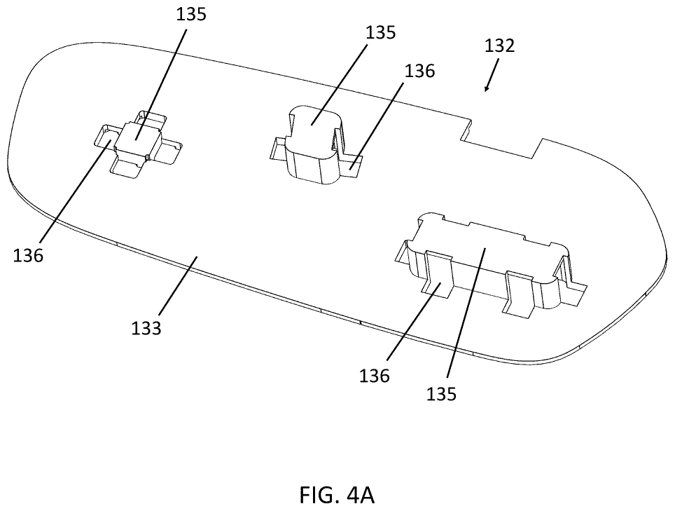

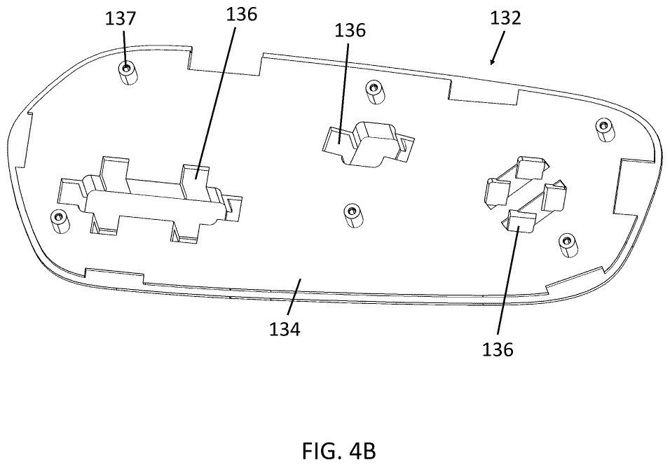

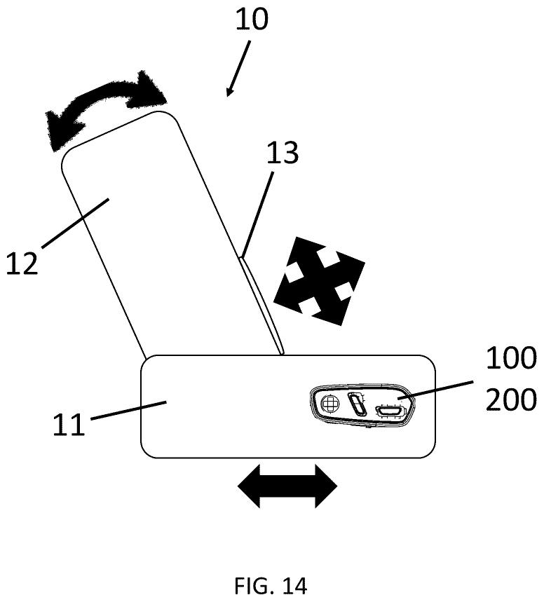

Referring to FIGS. 1-6D, a first implementation of a switch assembly 100 comprises a first housing 101, an interface plate 113, an actuator 124, a second housing 132, and a touch overlay 140. The first housing 101 defines fastener openings 102, through which fasteners 141 extend to couple the switch assembly 100 to a vehicle structure, such as a seat 10 (as shown in FIG. 14). The first housing 101 comprises a base 105 and a wall 104 extending away from the base 105. The wall 104, as shown, entirely circumscribes the base 105. The switch assembly may also comprise a controller 144, and one or more controller connector openings 112 may be formed in the first housing 101 to allow the switch assembly 100 to be electrically coupled to the controller 144 (as further described below). The controller connector openings 112 may be formed in either the base 105, the wall 104, or, as shown in FIG. 3A, at least partially in both the base 105 and the wall 104.

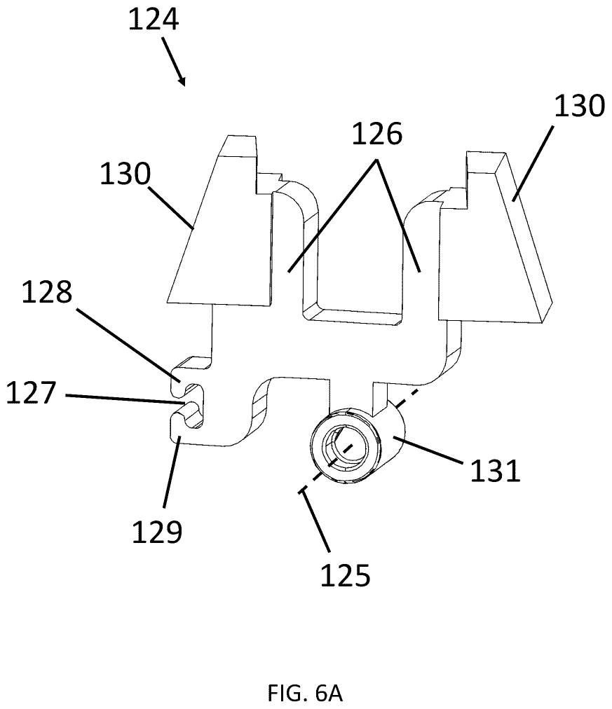

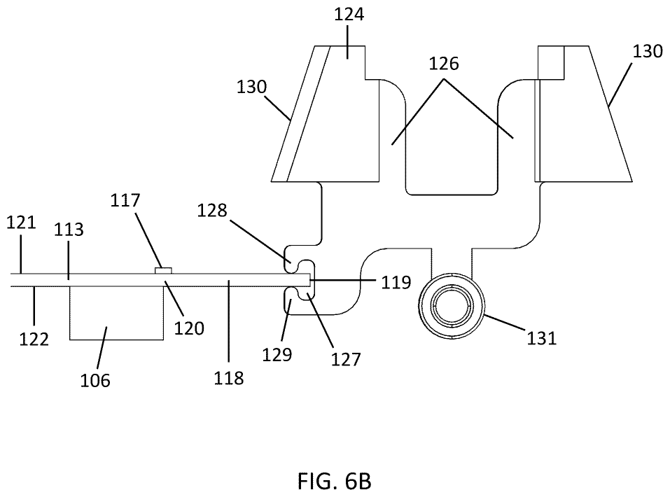

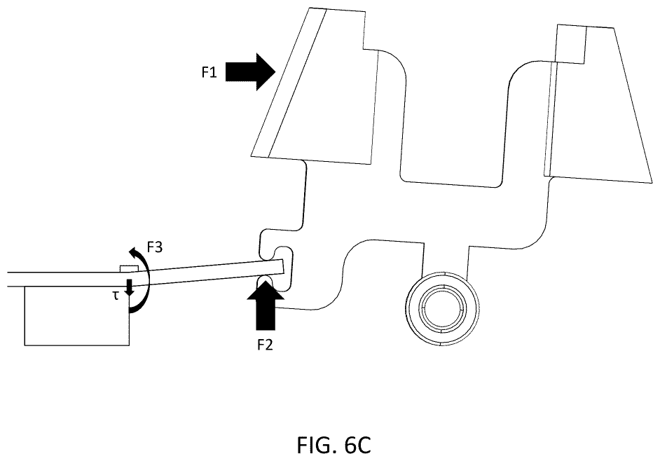

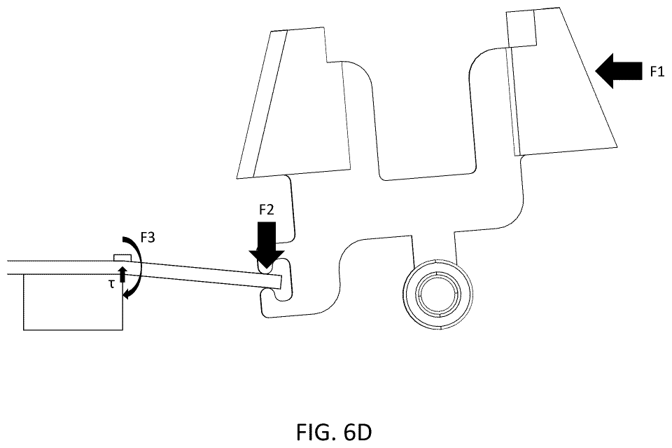

The first housing 101 further defines a support 106 defining fastener openings 107. The support 106 may extend away from the base 105. An interface plate 113 is coupled to the support 106, and therefore coupled to the first housing 101, by extending fasteners 143 through fastener openings 115 defined by the interface plate 113 and into the fastener openings 107 of the support 106. When coupled together in this way, a second surface 122 of the interface plate 113 will abut the support 106 of the first housing 101, as shown in FIG. 6B. In some implementations, the interface plate 113 of the switch assembly 100 may be a rigid printed circuit board (PCB). In some implementations, the first housing 101 and its various features may be formed from plastic using an injection molding process.

The interface plate 113 defines a cantilever 118 having a free end 119 and a fixed end 120 adjacent the support 106. The free end 119 of the cantilever 118 extends into an open space defined by an actuator opening 116 formed in the interface plate 113. Because the support 106 supports the fixed end 120 of the cantilever 118, the cantilever 118 can bend about the fixed end 120 when the free end 119 receives an appropriate force (further described below). Force sensors 117 are coupled to a first surface 121 of the interface plate 113 adjacent the fixed ends 120 and can measure a force imparted on the fixed ends 120 due to the bending of the cantilever 118. In some implementations, the force sensor 117 may be directly reflowed onto the interface plate 113 (i.e., PCB) via a reflow process.

An actuator 124 extends through the actuator opening 116 in the interface plate 113 and is coupled to the first housing 101. The first housing 101 comprises actuator clip protrusions 108, actuator clip walls 109 defining actuator clip ramps 110, and an actuator clip curved base 111. The actuator 124 comprises a drum 131 comprising a cylindrical shape. The drum 131 can be inserted in between the actuator clip protrusions 108 and actuator clip walls 109 to form a snap fit connection with the first housing 101. The actuator clip walls 109 define actuator clip ramps 110 such that the drum 131 can slide into the snap fit connection with reduced force. The actuator clip curved base 111 has a curved surface that matches the shape of the drum 131, thereby allowing the actuator 124 to rotate within the snap fit connection.

The actuator 124 further comprises arms 126 and defines a groove 127. Adjacent the groove 127 are a first clamping tab 128 and a second clamping tab 129. The arms 126 comprise actuation surfaces 130 for operators of the switch assembly 100 to push against. The actuator 124 further comprises an axis of rotation 125, wherein pushing against an actuation surface 130 will cause the actuator 124 to rotate about the axis of rotation 125 when the actuator is coupled to the first housing 101. As shown in FIG. 6A, the axis of rotation 125 corresponds to a central axis of the cylindrically shaped drum 131. Referring now to FIG. 6B, the free end 119 of the cantilever 118 of the interface plate 113 is disposed within the groove 127 and the first clamping tab 128 abuts the first surface 121 of the interface plate 113 and the second clamping tab 129 abuts the second surface 122 of the interface plate 113. The clamping tabs 128, 129 need not abut the surfaces 121, 122 at all times but must be able to contact the surfaces 121, 122 when the actuator 124 rotates in order to bend the cantilever 118. In some implementations, the actuator 124 and its various features may be formed from plastic using an injection molding process.

When viewed from the side such as shown in FIGS. 6C-6D, the actuator 124 is capable of rotating in both a clockwise and counterclockwise direction and is therefore capable of bending the cantilever 118 up and down. It is to be understood that the directions of movement may be different depending on the orientation of the switch assembly 100, so the references to clockwise, counterclockwise, up, and down are for simplicity and clarity when referring to the particular example shown in FIGS. 6C-6D. For example, in some implementations, the switch assembly 100 may be installed in a vehicle in an orientation such that the cantilever 118 bends from left to right.

Referring to FIG. 6C, when a first force F1 causes the actuator 124 to rotate about the axis of rotation 125 in the clockwise direction, the actuator 124 exerts a second force F2 in the up direction adjacent the free end 119 of the cantilever 118 causing the cantilever 118 to bend about the fixed end 120, wherein the bending of the cantilever 118 about the fixed end 120 induces a third force F3 exerted on the fixed end 120 and measured by the force sensor 117. Referring to FIG. 6D, when a first force F1 causes the actuator 124 to rotate about the axis of rotation 125 in the counterclockwise direction, the actuator 124 exerts a second force F2 in the down direction adjacent the free end 119 of the cantilever 118 causing the cantilever 118 to bend about the fixed end 120, wherein the bending of the cantilever 118 about the fixed end 120 induces a third force F3 exerted on the fixed end 120 and measured by the force sensor 117. In both examples, the third force F3 may comprise a bending moment. In addition, the third force F3 may further comprise a shear force tau (τ) in a vertical direction as indicated in FIGS. 6C-6D.

The force sensor 117 may be any device or structure that can transform force into a signal. The signal can be, but is not limited to, electrical, electronic (digital or analog), mechanical, or optical. For example, in some implementations, the force sensor 117 is a microelectromechanical systems (MEMS) sensor. In one example, the MEMS sensor is a structure-based piezo-resistive sensor. When the actuator 124 causes the cantilever 118 to bend, the force sensor 117 will be affected, directly and/or indirectly, by the third force F3 and therefore will measure the third force F3 and provide a signal to the controller 144 for processing. The force sensor 117 may measure F3 including applying an offset, for example in the case where the switch assembly 100 is installed in a high-vibration environment or if the force sensor only indirectly measures a force correlative to F3 that is induced on the force sensor 117 by compression, strain, etc., as a result of F3.

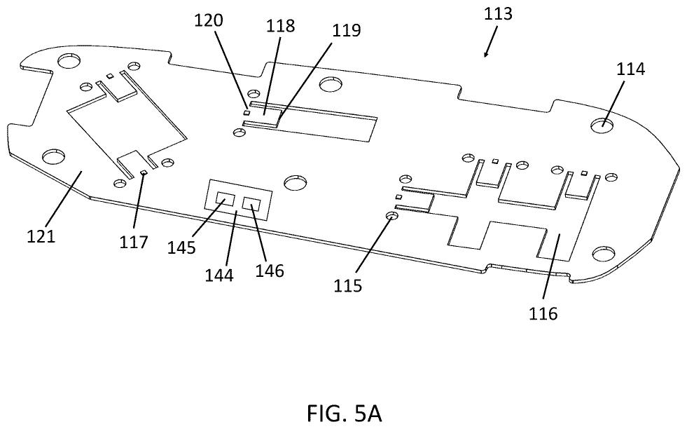

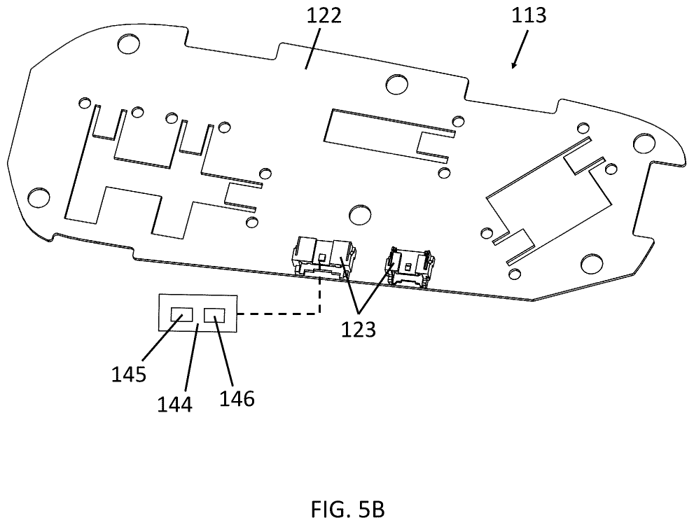

The controller 144 comprises a processor 145 and a memory 146. The memory 146 stores software instructions for execution by the processor 145 to control the switch assembly 100. In some implementations, the interface plate 113 is a PCB and the controller 144, as shown in FIG. 5A, may be directly coupled to the PCB. In other implementations, as shown in FIG. 5B, the controller 144 may be installed elsewhere within the switch assembly 100 or the vehicle, as represented by the dashed line. The connection between the switch assembly 100 and the controller 144 may be effectuated via a wiring harness extending from controller connectors 123 coupled to the interface plate 113 or via a wireless signal, for example. The software instructions may cause the processor 145 to receive a signal from the force sensor 117 and control a vehicle function based on the signal received from the force sensor 117.

A second housing 132 may be coupled to the first housing 101 to encapsulate the interface plate 113 within the switch assembly 100. The base 105 of the first housing 101 defines fastener openings 103 and the second housing 132 comprises corresponding fastener openings 137 (e.g., blind holes) extending from a second surface 134 of the second housing 132. Fasteners 142 extend through the fastener openings 103 in the first housing 101, through fastener openings 114 in the interface plate 113, and into the fastener openings 137 of the second housing 132 to couple the first housing 101 to the second housing 132 with the interface plate 113 disposed between them. In some implementations, the second housing 132 and its various features may be formed from plastic using an injection molding process.

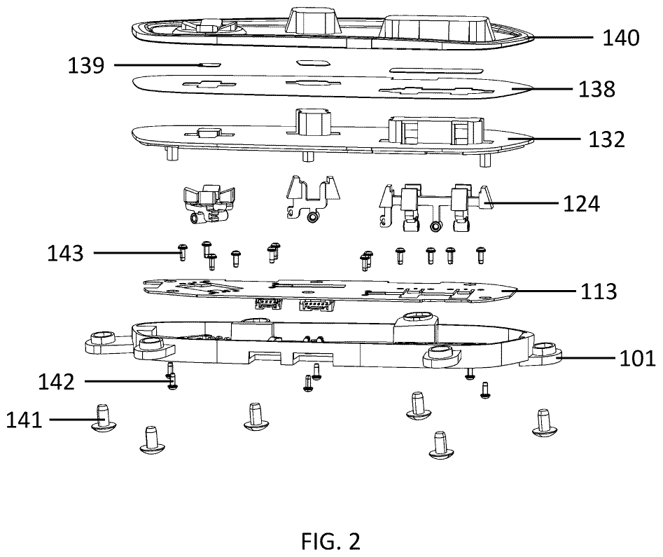

The second housing 132 defines an actuator opening 136 and a coupling surface 135 extending from a first surface 133 of the second housing 132. The arms 126 of the actuator 124 extend through the actuator opening 136 such that the actuation surfaces 130 are adjacent the coupling surface 135. Adhesives 138 and 139, as shown in FIG. 2, may be coupled to the first surface 133 and the coupling surface 135 respectively, and a touch overlay 140 may be coupled to the adhesives 138 and 139 such that the touch overlay 140 is coupled to, and covers the entirety of, the second housing 132. The touch overlay 140 may define a groove around its outer perimeter into which the wall 104 of the first housing 101 extends. Alternatively, or additionally, the touch overlay 140 may comprise snap features that couple to the arms 126 of the actuator 124 via an interference fit.

An operator of the switch assembly 100 may interact with the actuation surfaces 130 of the actuators 124 by applying force to the touch overlay 140 adjacent the actuation surfaces 130. Therefore, the touch overlay 140 is made from an elastic material that can deform locally when pressed upon by the operator. In some implementations, the elastic material is silicone or a thermoplastic elastomer such as thermoplastic vulcanizate (TPV). In some implementations, the touch overlay 140 and its various features may be formed using an injection molding process.

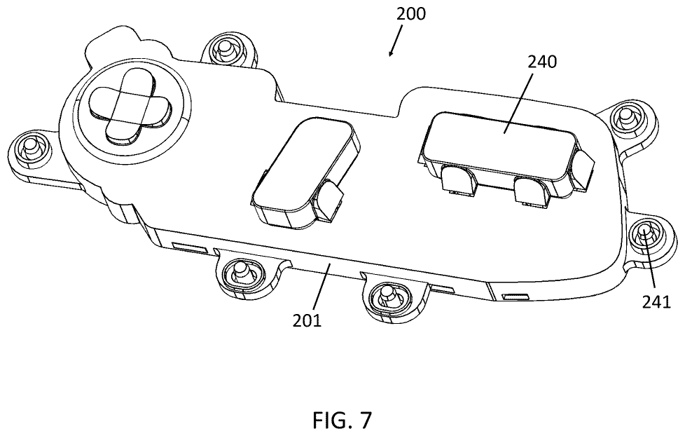

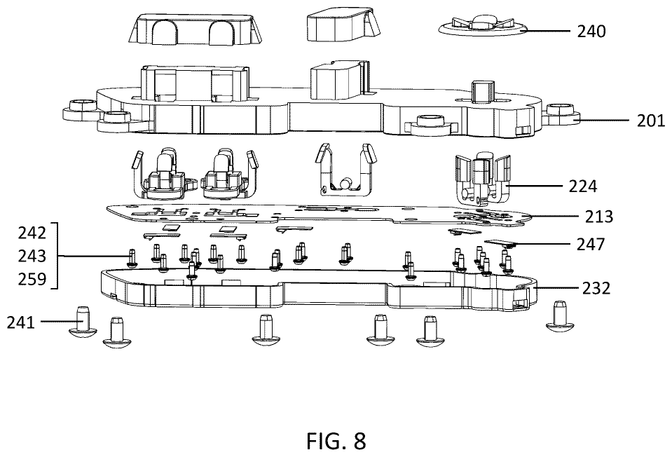

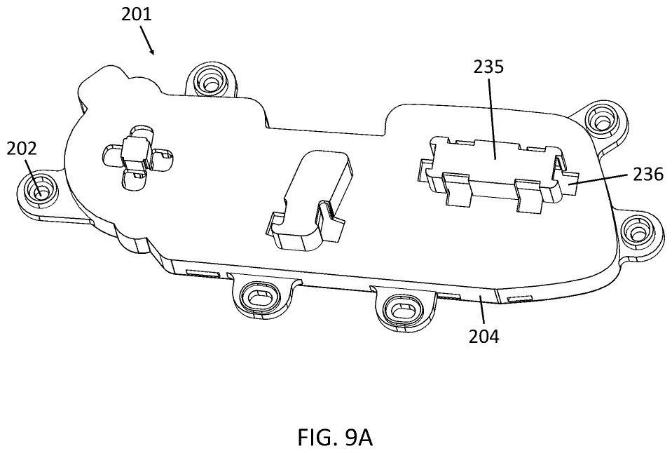

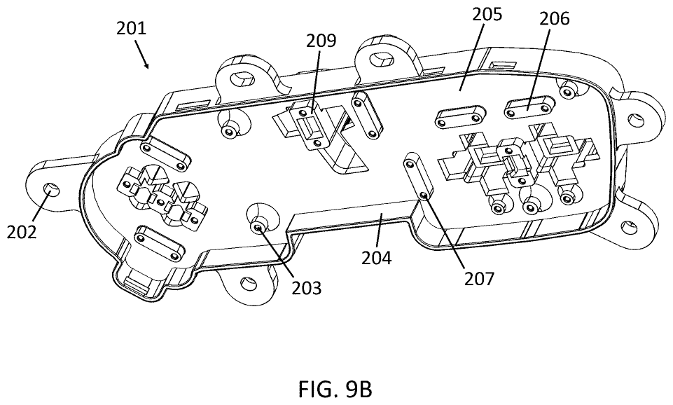

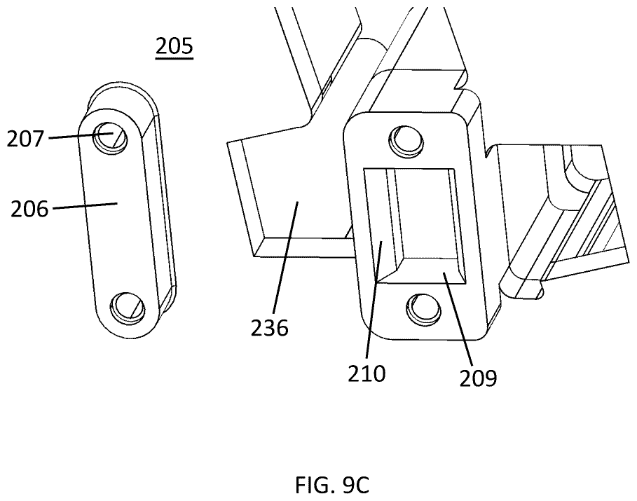

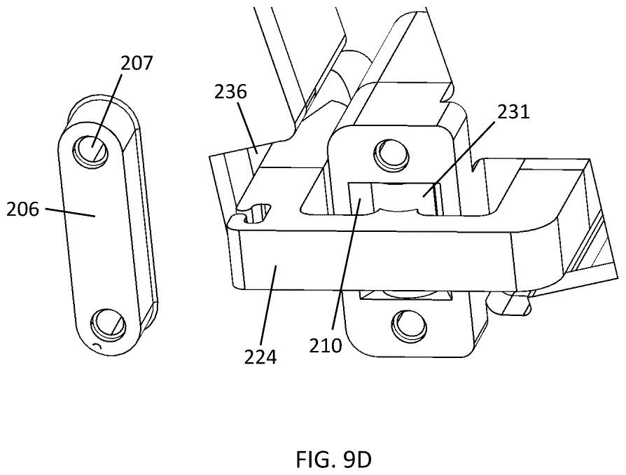

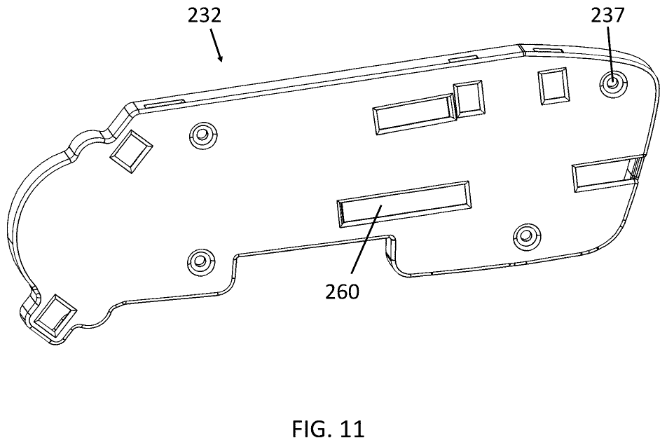

Referring now to FIGS. 7-13D, a second implementation of a switch assembly 200 comprises a first housing 201, an interface plate 213, an actuator 224, a second housing 232, and a touch overlay 240. The first housing 201 defines fastener openings 202, through which fasteners 241 extend to couple the switch assembly 200 to a vehicle structure, such as the seat 10 (as shown in FIG. 14). The first housing 201 comprises a base 205 and a wall 204 extending away from the base 205. The wall 204, as shown, entirely circumscribes the base 205.

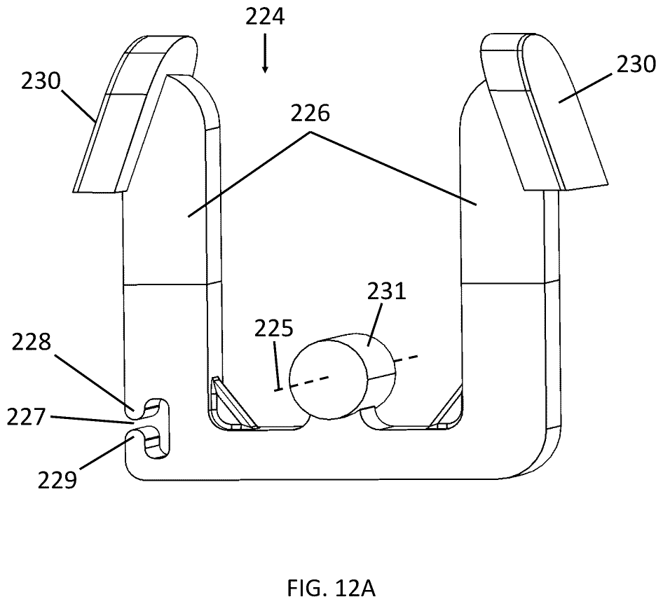

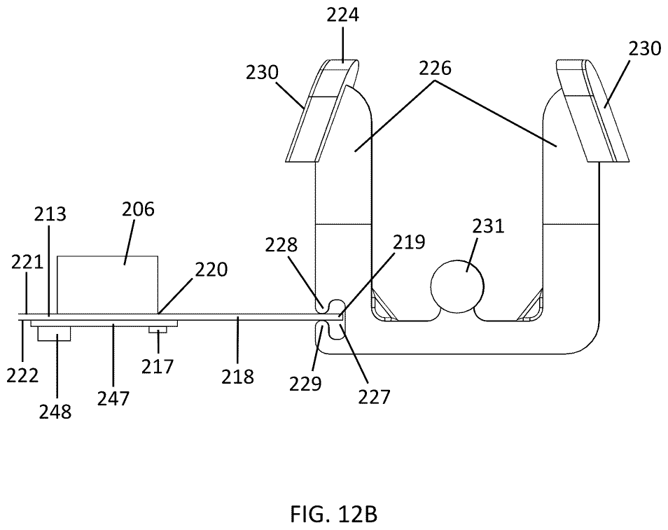

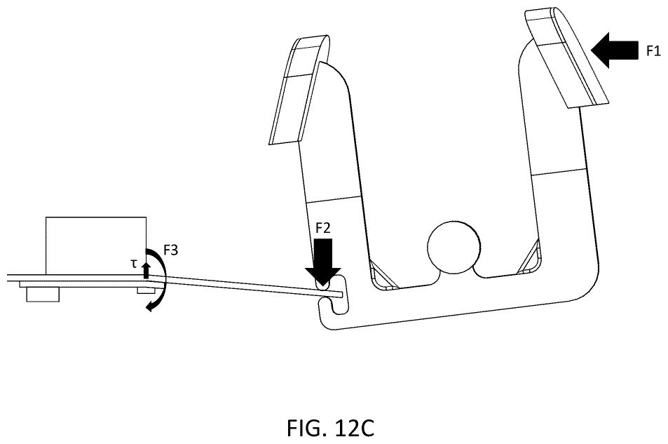

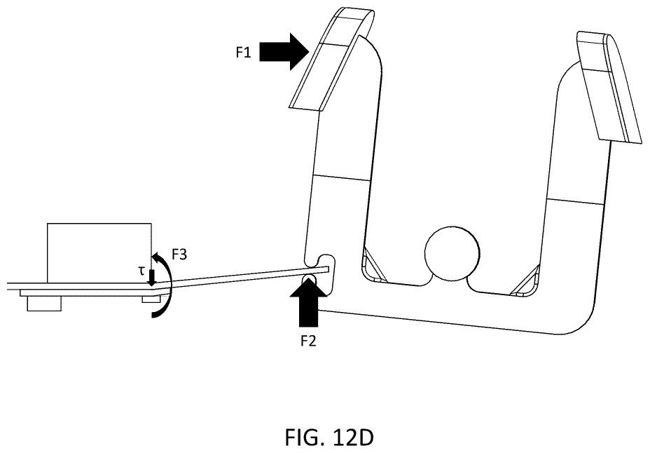

The first housing 201 further defines a support 206 defining fastener openings 207. The support 206 may extend away from the base 205. An interface plate 213 is coupled to the support 206, and therefore coupled to the first housing 201, by extending fasteners 243 through fastener openings 215 defined by the interface plate 213 and into the fastener openings 207 of the support 206. When coupled together in this way, a first surface 221 of the interface plate 213 will abut the support 206 of the first housing 201, as shown in FIG. 12B. In some implementations, the interface plate 213 of the switch assembly 200 may be a rigid piece of plastic or metal formed by injection molding or stamping, respectively. In some implementations, the first housing 201 and its various features may be formed from plastic using an injection molding process.

The interface plate 213 defines a cantilever 218 having a free end 219 and a fixed end 220 adjacent the support 206. The free end 219 of the cantilever 218 extends into an open space defined by an actuator opening 216 formed in the interface plate 213. Because the support 206 supports the fixed end 220 of the cantilever 218, the cantilever 218 can bend about the fixed end 220 when the free end 219 receives an appropriate force (further described below). Force sensors 217 are coupled to a second surface 222 of the interface plate 213 adjacent the fixed ends 220 and can measure a force imparted on the fixed ends 220 due to the bending of the cantilever 218.

An actuator 224 extends through the actuator opening 216 in the interface plate 213 and is coupled to the first housing 201. The first housing 201 comprises actuator clip walls 209 defining actuator clip ramps 210. The actuator 224 comprises a drum 231 comprising a cylindrical shape. The drum 231 can be inserted in between the actuator clip walls 209 to form a snap fit connection with the first housing 201. The actuator clip walls 209 define actuator clip ramps 210 such that the drum 231 can slide into the snap fit connection with reduced force.

The actuator 224 further comprises arms 226 and defines a groove 227. Adjacent the groove 227 are a first clamping tab 228 and a second clamping tab 229. The arms 226 comprise actuation surfaces 230 for operators of the switch assembly 200 to push against. The actuator 224 further comprises an axis of rotation 225, wherein pushing against an actuation surface 230 will cause the actuator 224 to rotate about the axis of rotation 225 when the actuator is coupled to the first housing 201. As shown in FIG. 12A, the axis of rotation 225 corresponds to a central axis of the cylindrically shaped drum 231. Referring now to FIG. 12B, the free end 219 of the cantilever 218 of the interface plate 213 is disposed within the groove 227 and the first clamping tab 228 abuts the first surface 221 of the interface plate 213 and the second clamping tab 229 abuts the second surface 222 of the interface plate 213. The clamping tabs 228, 229 need not abut the surfaces 221, 222 at all times but must be able to contact the surfaces 221, 222 when the actuator 224 rotates in order to bend the cantilever 218. In some implementations, the actuator 224 and its various features may be formed from plastic using an injection molding process.

When viewed from the side, as shown in FIGS. 12C-12D, the actuator 224 is capable of rotating in both a clockwise and counterclockwise direction and is therefore capable of bending the cantilever 218 up and down. It is to be understood that the directions of movement may be different depending on the orientation of the switch assembly 200, so the references to clockwise, counterclockwise, up, and down are for simplicity and clarity when referring to the particular example shown in FIGS. 12C-12D. For example, in some implementations, the switch assembly 200 may be installed in a vehicle in an orientation such that the cantilever 218 bends from left to right.

Referring to FIG. 12C, when a first force F1 causes the actuator 224 to rotate about the axis of rotation 225 in the counterclockwise direction, the actuator 224 exerts a second force F2 in the down direction adjacent the free end 219 of the cantilever 218 causing the cantilever 218 to bend about the fixed end 220, wherein the bending of the cantilever 218 about the fixed end 220 induces a third force F3 exerted on the fixed end 220 and measured by the force sensor 217. Referring to FIG. 12D, when a first force F1 causes the actuator 224 to rotate about the axis of rotation 225 in the clockwise direction, the actuator 224 exerts a second force F2 in the up direction adjacent the free end 219 of the cantilever 218 causing the cantilever 218 to bend about the fixed end 220, wherein the bending of the cantilever 218 about the fixed end 220 induces a third force F3 exerted on the fixed end 220 and measured by the force sensor 217. In both examples, the third force F3 may comprise a bending moment. In addition, the third force F3 may further comprise a shear force tau (τ) in a vertical direction as indicated in FIGS. 12C-12D.

The force sensor 217 may be any device or structure that can transform force into a signal. The signal can be, but is not limited to, electrical, electronic (digital or analog), mechanical, or optical. For example, in some implementations, the force sensor 217 is a microelectromechanical systems (MEMS) sensor. In one example, the MEMS sensor is a structure-based piezo-resistive sensor. The switch assembly may further comprise a controller 244 (described below), and when the actuator 224 causes the cantilever 218 to bend, the force sensor 217 will be affected by the third force F3 and therefore will measure the third force F3 and provide a signal to the controller 244 for processing. The force sensor 217 may measure F3 including applying an offset, for example in the case where the switch assembly 200 is installed in a high-vibration environment or if the force sensor only indirectly measures a force correlative to F3 that is induced on the force sensor 217 by compression, strain, etc., as a result of F3.

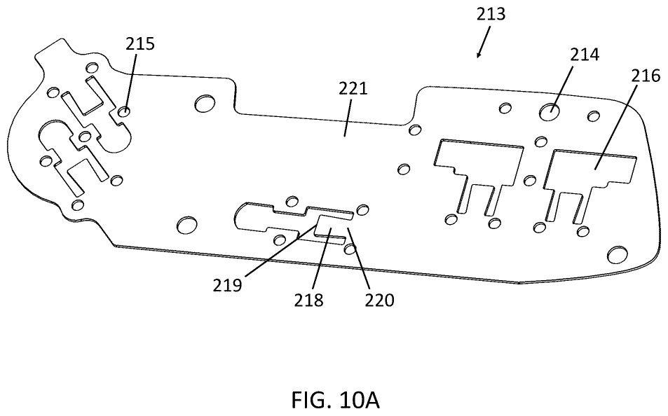

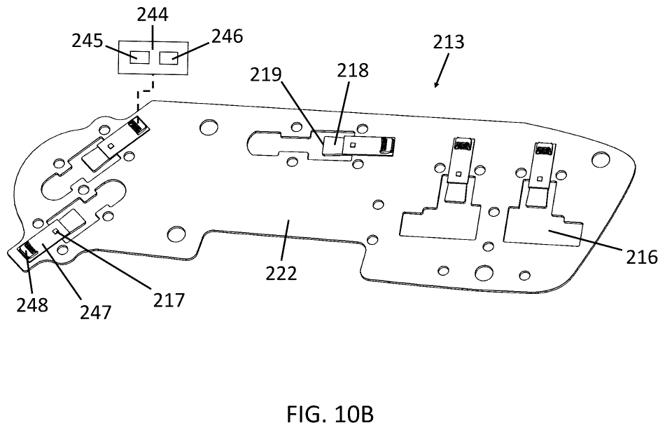

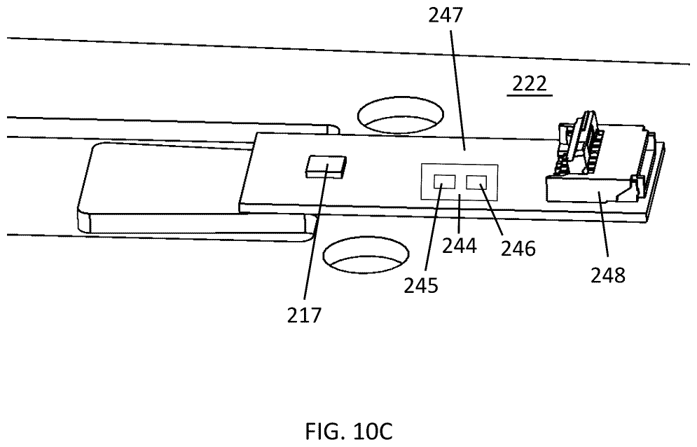

As shown in FIGS. 10B-10C, the interface plate 213 may be a rigid plastic or metal plate and the force sensor 217 is coupled to the second surface 222 of the interface plate 213 via a PCB 247. The PCB 247 may comprise a small strip shape that at least partially aligns with the cantilever 218 such that the force sensor 217 may be coupled to the PCB 247 in a location adjacent the fixed end 220 of the cantilever 218. A controller connector 248 is coupled to the PCB 247 to allow for an electrical connection of the force sensor 217 to other parts of the vehicle. In some implementations, the PCB 247 is coupled to the interface plate 213 via an adhesive. In some implementations, the force sensor 217 may be directly reflowed onto the PCB 247 via a reflow process.

The controller 244 comprises a processor 245 and a memory 246. The memory 246 stores software instructions for execution by the processor 245 to control the switch assembly 200. In some implementations, the controller 244, as shown in FIG. 10C, may be directly coupled to the PCB 247. In other implementations, as shown in FIG. 10B, the controller 244 may be installed elsewhere within the switch assembly 200 or the vehicle, as represented by the dashed line. The connection between the switch assembly 200 and the controller 244 may be effectuated via a wiring harness extending from the controller connector 248 or via a wireless signal, for example. The software instructions may cause the processor 245 to receive a signal from the force sensor 217 and control a vehicle function based on the signal received from the force sensor 217.

A second housing 232 may be coupled to the first housing 201 to encapsulate the interface plate 213 within the switch assembly 200. The second housing 232 defines fastener openings 237 and the first housing 201 defines corresponding fastener openings 203 (e.g., blind holes) extending from the base 205. Fasteners 242 extend through the fastener openings 237 in the second housing 232, through fastener openings 214 in the interface plate 213, and into the fastener openings 203 of the first housing 201 to couple the first housing 201 to the second housing 232 with the interface plate 213 disposed between them. The second housing 232 further defines a controller connection opening 260 to facilitate coupling the controller connector 248 to the controller 244 or to other parts of the vehicle. In some implementations, the second housing 232 and its various features may be formed from plastic using an injection molding process.

The first housing 201 defines an actuator opening 236 and a coupling surface 235 extending away from the actuator opening 236. The arms 226 of the actuator 224 extend through the actuator opening 236 such that the actuation surfaces 230 are adjacent the coupling surface 235. An adhesive may be coupled to the coupling surface 235 and a touch overlay 240 may be coupled to the first housing 201 via the adhesive such that the touch overlay 240 is coupled to and covers the entirety of the coupling surface 235 and the actuation surfaces 230. Alternatively, or additionally, the touch overlay 240 may comprise snap features that couple to the arms 226 of the actuator 224 via an interference fit.

An operator of the switch assembly 200 may interact with the actuation surfaces 230 of the actuators 224 by applying force to the touch overlay 240 adjacent the actuation surfaces 230. Therefore, the touch overlay 240 is made from an elastic material that can deform locally when pressed upon by the operator. In some implementations, the elastic material is silicone or a thermoplastic elastomer such as thermoplastic vulcanizate (TPV). In some implementations, the touch overlay 240 and its various features may be formed using an injection molding process.

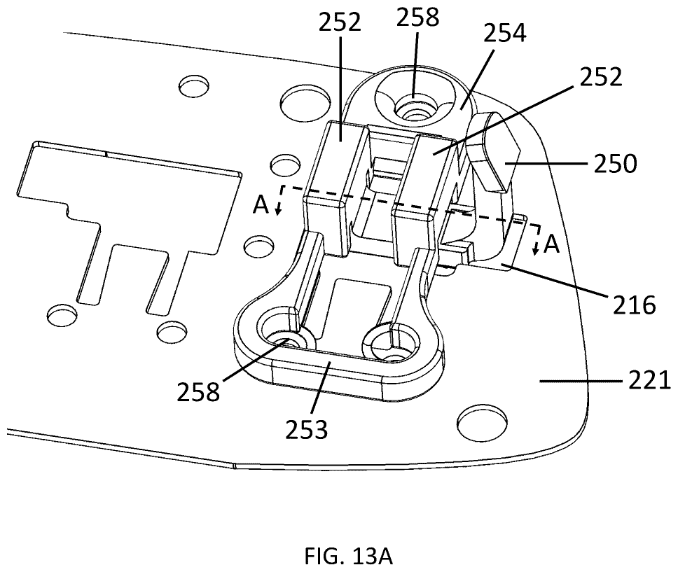

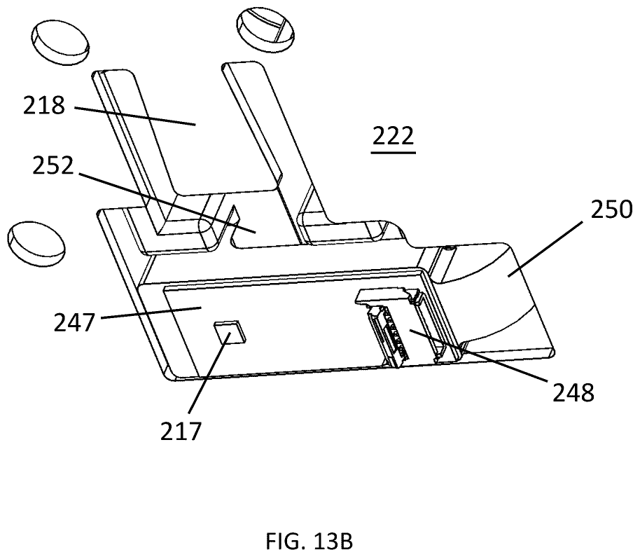

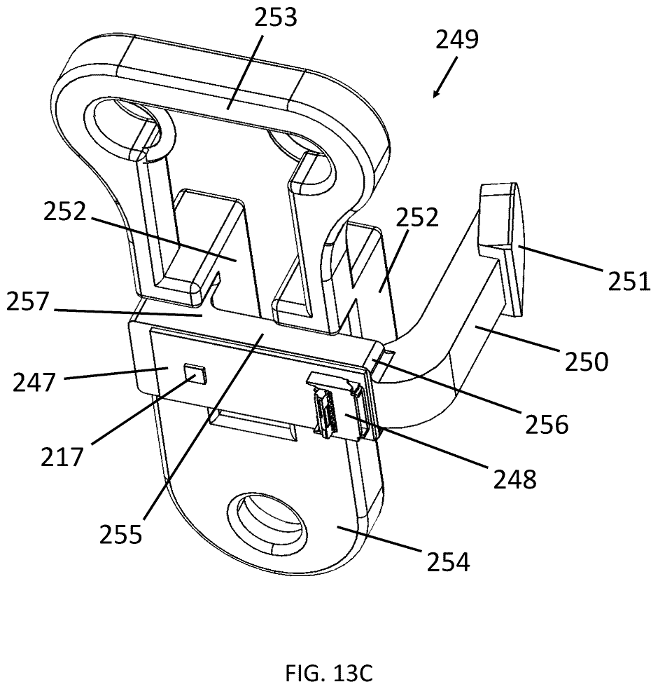

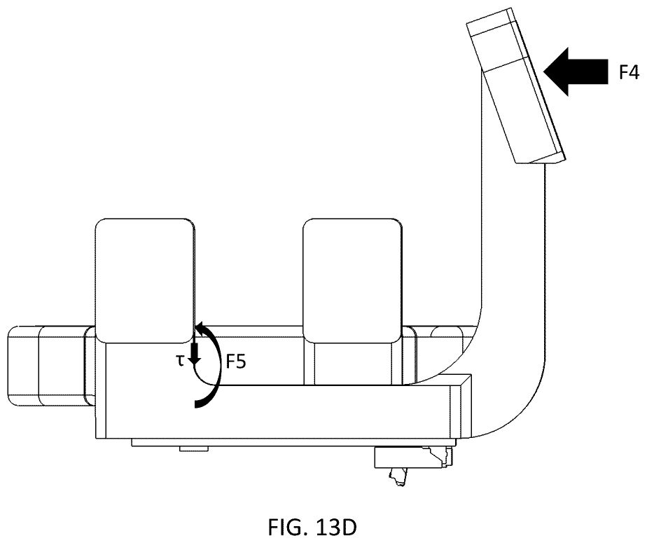

Referring now to FIGS. 13A-13C, the switch assembly 200 may comprise a second actuator 249. The second actuator 249 defines a cantilever system integrally with its own structure. The second actuator 249 comprises a cantilever 255 having a free end 256 and a fixed end 257. An arm 250 is coupled to the free end 256. For example, as shown in FIG. 13C, the arm 250 extends from the free end 256 and is otherwise free from any physical connections, thus maintaining the free-moving nature of the free end 256. The arm 250 comprises an actuation surface 251 for an operator to push against.

The fixed end 257 of the cantilever 255 is coupled to a bridge 252. As shown in FIGS. 13A-13C, the second actuator 249 may include two bridges 252 extending from a first base portion 253 to a second base portion 254. The first base portion 253 and the second base portion 254 define fastener openings 258 to facilitate coupling the second actuator 249 to the interface plate 213 using fasteners 259. The structure of the bridges 252 and the coupling of the second actuator 249 to the interface plate 213 ensures that the fixed end 257 remains rigidly in place. In some implementations, the second actuator 249 and its various features may be formed from plastic using an injection molding process.

Similar to the implementation described above, a PCB 247 may be coupled to the cantilever 255. The PCB 247 may comprise a small strip shape that is coupled to the cantilever 255 such that the force sensor 217 may be coupled to the PCB 247 in a location adjacent the fixed end 257 of the cantilever 255. A controller connector 248 is coupled to the PCB 247 to allow for an electrical connection of the force sensor 217 to other parts of the vehicle. In some implementations, the PCB 247 is coupled to the cantilever 255 via an adhesive. In some implementations, the force sensor 217 is coupled to the PCB 247 via a reflow process.

Referring to FIG. 13D, when a fourth force F4 pushes against the actuation surface 251, the arm 250 will cause the free end 256 of the cantilever 255 to bend upward. The bending of the cantilever 255 about the fixed end 257 induces a fifth force F5 exerted on the fixed end 257 and measure by the force sensor 217. The fifth force F5 may comprise a bending moment. In addition, the fifth force F5 may further comprise a shear force tau (τ) in a vertical direction as indicated in FIG. 13D. It is to be understood that the directions of movement may be different depending on the orientation of the switch assembly 200, so the references to upward movement are for simplicity and clarity when referring to the particular example shown in FIG. 13D. For example, in some implementations, the switch assembly 200 may be installed in a vehicle in an orientation such that the cantilever 255 bends from left to right.

As shown in FIG. 14, by way of non-limiting example, controlling the vehicle function may comprise controlling a seating position of the vehicle seat 10. The vehicle seat 10 comprises a seat bottom 11, a seat back 12, and a lumbar support 13 coupled to the seat back 12. A switch assembly 100/200 is coupled to the seat bottom 11. As shown by the arrows, the seat back 12 may move in two opposite arc directions to change a seat back recline position, the seat bottom 11 may move in two opposite linear directions to change a seat bottom forward/rearward position, and the lumbar support 13 may move in four directions to change a seat lumbar support position (closer to/further from an occupant's back and further up/down along the seat back 12). Controlling other vehicle functions using the switch assembly 100/200 is contemplated, such as adjusting stereo volume, adjusting cruise control, adjusting mirror positions, etc. In addition, in other implementations, the switch assembly can be used to control functions of other devices, such as consumer electronics or home appliances.

The processor 145/245 and memory 146/246 may be any type of processor and memory as known in the art that is suitable for vehicle use. The processor 145/245 may be a standard programmable processor that performs arithmetic and logic operations necessary for operation of the switch assembly. The processor 145/245 may be configured to execute program code encoded in tangible, computer-readable media. For example, the processor 145/245 may execute program code stored in the memory 146/246, which may be volatile or non-volatile memory. The memory 146/246 is only one example of tangible, computer-readable media. In one aspect, the controller 144/244 can be considered an integrated device such as firmware. Other examples of tangible, computer-readable media include DVDs, hard drives, flash memory, or any other machine-readable storage media, wherein when the program code is loaded into and executed by a machine, such as the processor 145/245, the machine becomes an apparatus for practicing the disclosed subject matter.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terminology used herein is for the purpose of describing particular implementations only and is not intended to be limiting of the disclosure. As used herein, the singular forms “a”, “an,” and “the” are intended to include the plural forms as well, unless the context clearly indicates otherwise. For example, as clearly shown in the FIGURES, the switch assembly 100/200 may comprise a plurality of actuators 124/224 and corresponding features such as a plurality of supports 106/206, actuator openings 116/216, etc. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “coupled,” “connected,” and the like as used herein to mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

1. A switch assembly comprising:
an actuator comprising an axis of rotation and defining a groove;
an interface plate defining a cantilever having a fixed end and a free end, the free end being disposed within the groove; and
a force sensor coupled to the interface plate adjacent the fixed end;
wherein, when a first force causes the actuator to rotate about the axis of rotation, the actuator exerts a second force on the cantilever causing the cantilever to bend about the fixed end.

2. The switch assembly of claim 1, wherein the bending of the cantilever about the fixed end induces a third force exerted on the fixed end and measured by the force sensor.

3. The switch assembly of claim 2, wherein the third force comprises a bending moment.

4. The switch assembly of claim 1, further comprising a housing, wherein the actuator is coupled to the housing.

5. The switch assembly of claim 4, wherein the housing is coupled to the interface plate.

6. The switch assembly of claim 4, wherein the housing defines a support and the interface plate comprises a surface, wherein the support abuts the surface adjacent the fixed end.

7. The switch assembly of claim 4, further comprising a touch overlay coupled to the housing.

8. The switch assembly of claim 7, wherein the touch overlay is coupled to the actuator using an interference fit.

9. The switch assembly of claim 7, wherein the touch overlay is coupled to the housing using an adhesive.

10. The switch assembly of claim 1, wherein the interface plate is a printed circuit board (PCB).

11. The switch assembly of claim 10, wherein the force sensor is coupled to the PCB.

12. The switch assembly of claim 11, wherein the force sensor is directly reflowed onto the PCB.

13. The switch assembly of claim 1, wherein the force sensor is coupled to a printed circuit board (PCB), wherein the PCB is coupled to the interface plate such that the force sensor is adjacent the fixed end.

14. The switch assembly of claim 13, wherein the PCB is coupled to the interface plate using an adhesive.

15. The switch assembly of claim 13, wherein the force sensor is directly reflowed onto the PCB.

16. The switch assembly of claim 10, further comprising a controller having a processor and a memory, wherein instructions stored on the memory cause the processor to receive a signal from the force sensor.

17. The switch assembly of claim 16, wherein the controller is coupled to the PCB.

18. The switch assembly of claim 1, further comprising a controller having a processor and a memory, wherein instructions stored on the memory cause the processor to receive a signal from the force sensor.

19. The switch assembly of claim 18, wherein the switch assembly is installed in a vehicle and the instructions further cause the processor to control a vehicle function based on the signal received from the force sensor.

20. The switch assembly of claim 19, wherein controlling a vehicle function comprises controlling a seating position of a vehicle seat, wherein the seating position comprises a seat back recline position, a seat bottom forward/rearward position, or a seat lumbar support position.

21-37. (canceled)
